(19) United States
(12) Patent Application Publication
(10) Pub. No.: US 2014/0307175 A1
(43) Pub. Date: Oct. 16, 2014

(54) LIGHTING DEVICE, DISPLAY DEVICE AND TELEVISION DEVICE

(71) Applicant: Sharp Kabushiki Kaisha, Osaka-shi, Osaka (JP)

(72) Inventor: Hidekazu Oka, Osaka-shi, Osaka (JP)

(73) Assignee: Sharp Kabushiki Kaisha, Osaka-shi, Osaka (JP)

(21) Appl. No.: 14/356,613

(22) PCT Filed: Nov. 15, 2012
(86) PCT No.: PCT/JP2012/079620

§ 371 Date: May 7, 2014

(30) Foreign Application Priority Data
Nov. 22, 2011 (JP) 2011-255248

(51) Int. Cl. F21V 8/00

(52) U.S. Cl. CPC G02B 6/0068; G02B 6/009
USPC 348/790; 362/613; 362/612; 349/65

(57) ABSTRACT

A lighting device 10 according to this invention includes a light guide plate 16, a reflection sheet 21, and a light source unit LU. The light guide plate 16 is a plate-like member and includes a light entrance surface 16c through which light enters and a light exit surface 16a through which the light in the light guide plate 16 from the light entrance surface 16c exits. The reflection sheet 21 is arranged such that a front surface 21a thereof is on a rear plate surface 16b of the light guide plate 16 and such that an end portion 211 of the reflection sheet 21 is located more to an outer side than the light entrance surface 16c. The light source unit LU includes a light source board 18, a plurality of light sources 17, and a connector 19A configured to relay an electric power supply to the light sources 17. The light sources 17 and the connector 19A are mounted on the light source board 18 such that the light sources 17 are opposite the light entrance surface 16c and the connector 19A is located on a rear surface 21b side of the end portion 211 of the reflection sheet 21.

### TECHNICAL FIELD

This invention relates to a lighting device, a display device, and a television device.

### BACKGROUND ART

A liquid crystal panel is used for a display device such as a television device, a mobile phone, and a handheld terminal. The liquid crystal panel requires light to display an image. Therefore, as disclosed in Patent Document 1, the display device includes a lighting device (or a backlight device) together with the liquid crystal panel. The lighting device that is arranged on a back side of the liquid crystal panel emits planar light toward a back surface of the liquid crystal panel.

As disclosed in Patent Document 1, an edge-light type (or side-light type) lighting device including a light guide plate and a light source unit is known. The light guide plate is a transparent plate-like member. The light source unit is arranged opposite an end surface of the light guide plate. As a light source unit, a unit including multiple LEDs that are mounted on a longitudinal LED board (hereinafter, LED unit) is widely used in this kind of lighting device in recent years.

There is a demand for large-size LED units according to an increase in size of lighting devices in recent years. Therefore, an LED board included in the LED unit is also required to have a larger length than conventional LED boards. However, there is a length limit for the LED boards that can be produced by an existing facility. Establishing new facilities to produce LED units for larger lighting devices increases the production cost, which is not preferable. For such a reason, multiple LED boards are prepared in a size (length) that can be produced by the existing facility. The LED boards are connected in line and used as an LED unit for a large size lighting device. Each LED board includes a connector mounted thereon. The connector is configured to relay an electric power supplied from an external device to the LEDs on the LED board. An external part of the connector is normally a plastic housing.

### RELATED ART DOCUMENT

### Patent Document

Patent Document 1: Japanese Unexamined Patent Application Publication No. 2002-75038

### Problem to be Solved by the Invention

In such a lighting device, the connectors on the LED boards may be arranged opposite an end surface of a light guide plate through which light from the LEDs enters the light guide plate. If three or more LED boards are arranged in line, all of the connectors except for the connectors on the LED boards at the ends are opposite the end surface of the light guide plate. In such a case, an amount of light that enters the light guide plate through a portion of the end surface of the light guide plate opposite the connector (housing) is significantly small compared to other portions of the light guide plate. Therefore, uneven brightness occurs in the light emitted by the lighting device due to the connectors.

As described earlier, the external part of the connector is the plastic housing. When the light from the LED hits the housing, some amount of the light is absorbed by the housing. Further, if the connector is mounted on the LED board, the LED cannot be mounted on the portion where the connector is mounted. For such a reason, arranging the connector on the LED board so as to face the end surface of the light guide plate is a problem.

### DISCLOSURE OF THE PRESENT INVENTION

An object of this invention is to provide a lighting device and the like in which uneven brightness due to a connector that is arranged on a light source board is less likely to occur.

### Means for Solving the Problem

A lighting device according to this invention includes a light guide plate, a reflection sheet, and a light source unit. The light guide plate is a plate-like member. The light guide plate includes a light entrance surface through which light enters the light guide plate and a light exit surface through which the light that entered the light guide plate exits. The light entrance surface is an end surface of the plate-like member. The light exit surface is a front plate surface of the plate-like member. The reflection sheet is arranged such that a front surface thereof is on a rear plate surface of the light guide plate and such that an end portion of the reflection sheet is located on an outer side of the light entrance surface. The light source unit includes a plurality of light sources, a connector, and a light source board. The connector is configured to relay an electric power supply to the light sources. The light sources are mounted on the light source board such that the light sources are opposite the light entrance surface. The connector is mounted on the light source board such that the connector is located on a rear side of the end portion of the reflection sheet. In this configuration, since the connector is arranged on the rear side of the end portion of the reflection sheet, light emitted by the light source hardly meets the connector. Therefore, uneven brightness due to the connector is less likely to occur in the light emitted by the light source in the above lighting device.

In the lighting device, the light source board may include a longitudinal main body on which the light sources are mounted. The extension portion may extend outwardly from the main body. The extension portion includes the connector mounted thereon.

In the lighting device, the light source unit may include a plurality of light source units. The light source units may be arranged in line with each other along the light entrance surface.

In the lighting device, the light source units may have a same structure.

In the lighting device, the extension portion may be arranged about an end area in a longitudinal direction of the body portion.

In the lighting device, the extension portion may be arranged about an inner area in a longitudinal direction of the body portion.

In the lighting device, LED light sources are preferable for the light sources.

The display device according to this invention may further include the lighting device and a display panel configured to display using light from the lighting device.

In the display device, the display panel may be a liquid crystal panel including a pair of substrates with liquid crystals sealed therebetween.

A television device according to this invention may include the display device.

### Advantageous Effect of the Invention

According to this invention, a lighting device and the like in which uneven brightness due to a connector that is arranged on a light source board is less likely to occur can be provided.

### BRIEF DESCRIPTION OF THE DRAWINGS

FIG. 1 is an exploded perspective view illustrating a general configuration of a television device according to a first embodiment of this invention.

FIG. 2 is a back view of the television device.

FIG. 3 is an exploded perspective view illustrating a general configuration of a liquid crystal display unit in a liquid crystal display device.

FIG. 4 is a cross-sectional view of the liquid crystal display device taken along a short-side direction thereof.

FIG. 5 is an explanatory view schematically illustrating an arrangement of LED units and a reflection sheet.

FIG. 6 is a plan view of one of the LED units.

FIG. 7 is a plan view of one of the LED units.

FIG. 8 is a plan view of one of the LED units.

FIG. 9 is an explanatory view schematically illustrating an arrangement of LED units and a reflection sheet included in a lighting device according to a second embodiment.

FIG. 10 is a plan view of one of the LED units.

FIG. 11 is a plan view of one of the LED units.

FIG. 12 is an explanatory view schematically illustrating an arrangement of LED units and a reflection sheet included in a lighting device according to a third embodiment.

FIG. 13 is a plan view of an LED unit included in a lighting device according to a fourth embodiment.

### MODE FOR CARRYING OUT THE INVENTION

### First Embodiment

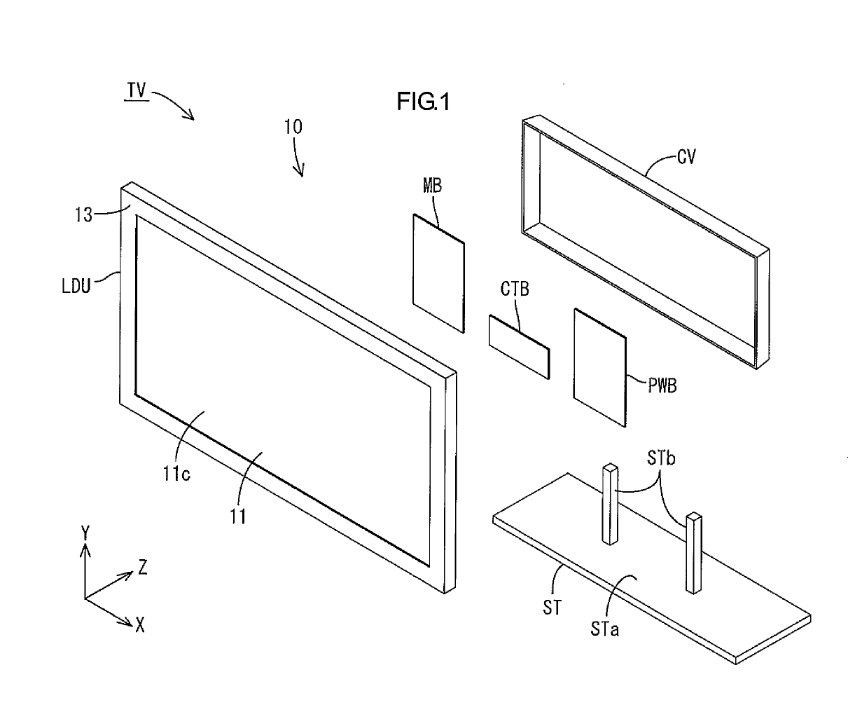

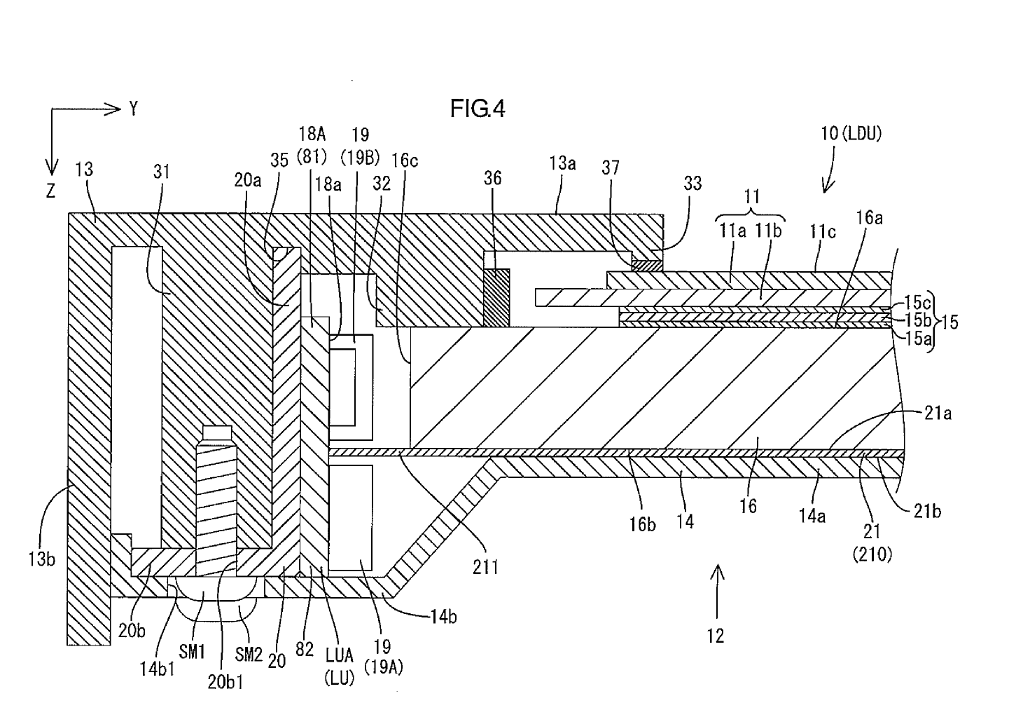

A first embodiment of this invention will be described with reference to FIGS. 1 to 8. According to this embodiment, a television device TV, a liquid crystal display device 10, and a lighting device 12 will be described. X-axis, Y-axis and Z-axis are indicated in some drawings. The axes in each drawing correspond to the respective axes in other drawings. The upper side and the lower side in FIG. 4 correspond to a front side (a display side) and a rear side (a back side), respectively.

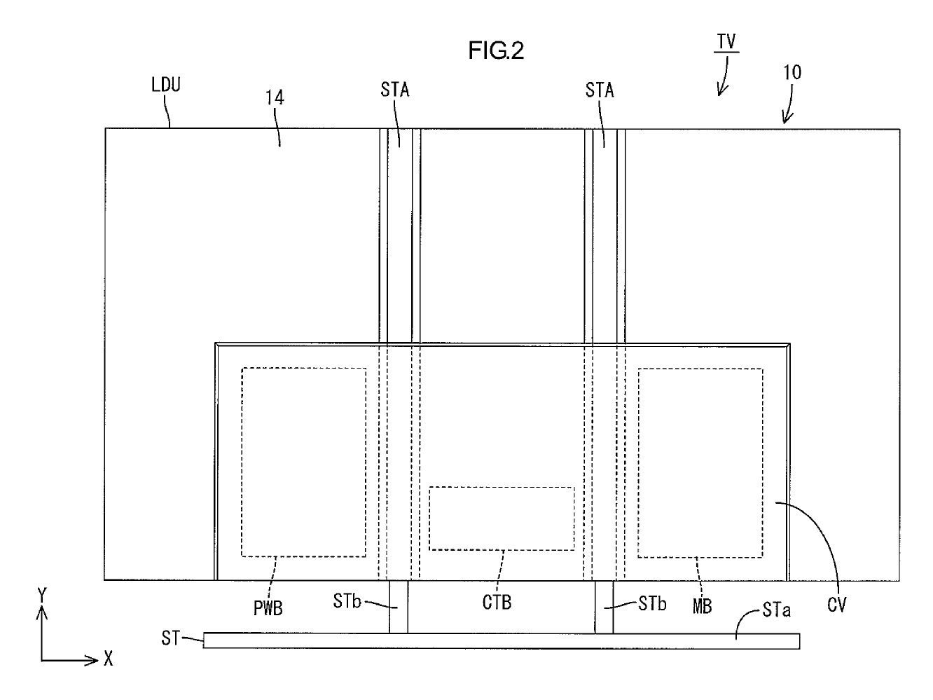

FIG. 1 is an exploded perspective view illustrating a general configuration of the television device TV according to the first embodiment of this invention. FIG. 2 is a back view of the television device TV. As illustrated in FIG. 1, the television device TV according to this embodiment includes a liquid crystal display unit LDU, boards PWB, MB, and CTB, a cover CV, and a stand ST. The boards PWB, MB, and CTB are attached on a rear side (a back side) of the liquid crystal display unit LDU. The cover CV is attached on the rear side of the liquid crystal display unit LDU so as to cover the boards PWB, MB, and CTB. The stand ST supports the liquid crystal display unit LDU such that a display surface 11c of the liquid crystal display unit LDU extends in the vertical direction (the Y-axis direction).

The liquid crystal display device 10 according to this embodiment has the same configuration as the television device TV except for at least a component (e.g. a tuner included in the main board MB) for receiving television signals. The liquid crystal display unit LDU has a landscape rectangular shape as a whole. The liquid crystal display unit LDU includes a liquid crystal panel 11 as a display panel and a lighting device 12 held together by a frame 13 and a chassis 14, which provide an external configuration of the liquid crystal display device 10.

As illustrated in FIG. 2, stand fitting members STA are attached to a rear surface of the chassis 14. The rear surface of the chassis 14 provides an external configuration of the back of the liquid crystal display device 10. The stand fitting members STA are away from each other in the X-axis direction and extend along the Y-axis direction on the chassis 14. Each stand fitting member STA has a cross section corresponds to a cross section of a channel beam and is open to the chassis 14. A space is provided between the stand fitting member STA and the chassis 14. Support portions STb included in the stand ST are arranged in the spaces provided between the stand fitting members STA and the chassis 14. The spaces provided inside the stand fitting members STA are paths for wiring members (e.g. electric wires). The wiring members are connected to LED boards 18 included in the lighting device 12. The stand ST includes a base STa and the support portions STb. The base STa extends parallel to the X-Z plane. The support portions STb stand on the base STa in the Y-axis direction. The cover CV is made of synthetic resin. The cover CV is attached to a part of the rear surface of the chassis 14. Specifically, the cover CV covers a substantially lower half part (refer to FIG. 2) of the chassis 14 so as to cross over the stand fitting members STA in the X-axis direction. A component storage space is provided between the cover CV and the chassis 14 such that the boards PWB, MB, and CTB, which will be described next, are arranged therein.

AS illustrated in FIG. 2, the liquid crystal display device 10 includes a power source board PWB, a main board MB, and a control board CTB as the boards PWB, MB, and CTB, respectively. The power source board PWB is a power source of the liquid crystal display device 10. The power source board PWB supplies drive power to the other boards MB and CTB and to the LEDs 17 included in the lighting device 12. The main board MB includes a tuner and an image processor, which are not illustrated. The tuner is configured to receive television signals. The image processor performs image processing on the received television signals. The main board MB is configured to output the processed image signals to the control board CTB. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which are sent from the main board MB, to driving signals for liquid crystals and to supply the driving signals to the liquid crystal panel 11.

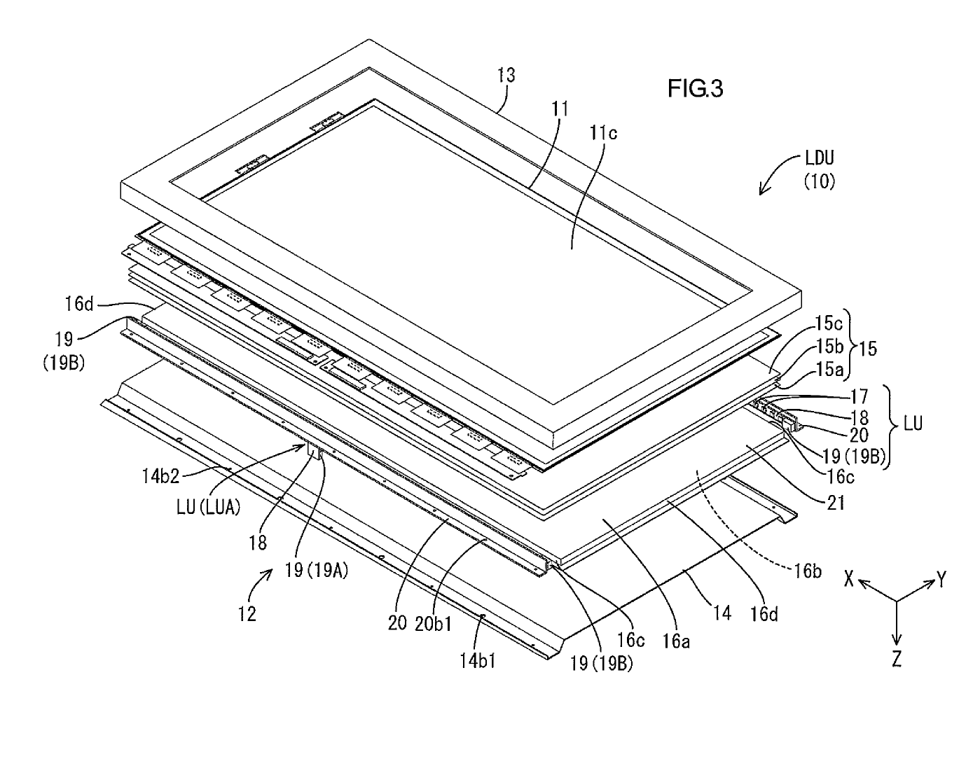

FIG. 3 is an exploded perspective view illustrating a general configuration of the liquid crystal display unit LDU included in the liquid crystal display device 10. FIG. 4 is a cross-sectional view illustrating a part of the liquid crystal display device 10 taken along a short-side direction thereof. As illustrated in FIGS. 3 and 4, main components of the liquid crystal display unit LDU included in the liquid crystal display device 10 are arranged between the frame (a front frame) 13 arranged on the front side and the chassis (a rear chassis) 14 arranged on the rear side. The main components arranged between the frame 13 and the chassis 14 include at least the liquid crystal panel 11, optical member 15, a light guide plate 16, LED units (light source units) LU, and a reflection sheet 21. The liquid crystal panel 11, the optical member 15, the light guide plate 16, and the reflection sheet 21 are placed on top of one another and held between the front frame 13 and the rear chassis 14. The lighting device 12 includes the optical member 15, the light guide plate 16, the LED units LU, the chassis 14, and the reflection sheet 21 as the main components. The LED units LU are arranged along long-side end surfaces 16c, 16c (the X-axis direction) of the light guide plate 16 between the frame 13 and the chassis 14. In this embodiment, three LED units LU (LUB1, LUA1, and LUB2) are arranged in line along each end surface 16c.

The liquid crystal panel 11 has a landscape rectangular shape in a plan view. The liquid crystal panel 11 includes a pair of glass substrates 11a and 11b and liquid crystals and liquid crystals. The substrates 11a and 11b having high light transmissivity are bonded together with a predetermined gap therebetween. The liquid crystals are sealed between the substrates 11a and 11b. One of the substrates 11a and 11b on the front side is a color filter substrate (hereinafter, referred to as a CF substrate) 11a and the other one of the substrates 11a and 11b on the rear side (on the backside) is an array substrate 11b. On the array substrate 11b, switching elements (e.g. TFTs: Thin Film Transistors), pixel electrodes, and an alignment film are arranged. The switching elements are connected to gate lines and source lines that are arranged perpendicular to each other. The pixel electrodes are connected to the switching elements. On the CF substrate 11a, color filters, counter electrodes, and an alignment film are arranged. The color filters (CF) include red (R), green (G), and blue (B) color portions that are arranged in a predetermined arrangement. Polarizing plates are arranged on the outer sides of the substrates 11a and 11b.

The liquid crystal panel 11 is placed on a front side of the optical member 15. A rear surface of the liquid crystal panel 11 (an outer surface of the polarizing plate on the rear side) is fitted to the optical member 15 with minimal gaps therebetween. Therefore, dust is less likely to enter the gaps between the liquid crystal panel 11 and the optical member 15. The display surface 11c of the liquid crustal panel 11 includes a display area and a non-display area. The display area is an inner area of a screen in which images are displayed. The non-display area is in an outer area of the screen around the display area and has a frame-like shape. The liquid crystal panel 11 is connected to the control board CTB via driver elements for driving liquid crystals and flexible boards. The liquid crystal panel 11 is configured to display an image in the display area of the display surface 11c based on signals from the control board CTB.

Similar to the liquid crystal panel 11, the optical member 15 has a landscape rectangular shape as a whole. The optical member 15 has about the same size (short-side dimension and long-side dimension) as the liquid crystal panel 11 and a plate surface 16a of the light guide plate 16 on the front side. The optical member 15 is placed on the front side (a light exit side) of the light guide plate 16 and sandwiched between the light guide plate 16 and the liquid crystal panel 11. In this embodiment, the optical member 15 includes three optical sheets that are placed on top of one another. Specifically, the optical member 15 includes a diffuser sheet 15a, a lens sheet 15b, and a reflecting type polarizing sheet 15c. As illustrated in FIGS. 3 and 4, the diffuser sheet 15a is arranged at the bottom and the reflection type polarizing sheet 15c is arranged at the top among the optical sheets.

The light guide plate 16 is a plate-like member made of substantially transparent (high transmissivity) synthetic resin (e.g. acrylic resin or polycarbonate such as PMMA) which has a refractive index sufficiently higher than that of air. The light guide plate 16 has a landscape rectangular shape in a plan view similar to the liquid crystal panel 11 and the optical member 15. A thickness of the light guide plate 16 is larger than that of the optical member 15. In each drawing, long-side directions and short-side directions of the plate surfaces 16a and 16b of the light guide plate 16 correspond to the X-axis direction and the Y-axis direction, respectively. Aboard thickness direction (a thickness direction) of the light guide plate 16 that is perpendicular to the plate surfaces 16a and 16b corresponds to the Z-axis direction. The light guide plate 16 is arranged on a rear side of the optical member 15 and sandwiched between the optical member 15 and the chassis 14. The LED units LU are arranged along the long-side direction of the light guide plate 16 such that light emitted by the LEDs 17 enters the light guide plate 16 through the end surface 16c in the long-side direction. The light guide plate 16 is configured to guide the light, which is emitted by the LEDs 17 and enters the light guide plate 16 through the end surfaces 16c, toward the optical member 15 (on the front side). The LED units LU are not arranged along short-end surfaces 16d of the light guide plate 16.

The front plate surface (a surface on the optical member 15 side) 16a of the light guide plate 16 is a light exit surface 16a. Through the light exit surface 16a, light exits the light guide plate 16 toward the optical member 15 and the liquid crystal panel 11. Among four end surfaces of the light guide plate 16 around the plate surfaces 16a and 16b, the long-side end surfaces 16c and 16c that extend in the X-axis direction are light entrance surfaces 16c and 16c. Each light entrance surface 16c is opposite the LEDs 17 (the LED board 18) with a predetermined space therebetween and light emitted by the LEDs 17 enters the light guide plate 16 from the light entrance surfaces 16c and 16c. The light entrance surface 16c extends parallel to the X-Z plane (a plate surface 18a of the LED board 18) and perpendicular to the light exit surface 16a. A direction of a relative arrangement between the LEDs 17 and the light entrance surface 16c corresponds to the Y-axis direction.

At least one of the light exit surface 16a and the plate surface 16b opposite the light exit surface 16a of the light guide plate 16 has a reflection portion (not illustrated) or a scattering portion (not illustrated). The reflection portion is configured to reflect the light inside the light guide plate 16. The scattering portion (not illustrated) is configured to scatter the light inside the light guide plate 16. The reflection portion or the scattering portion may be formed by patterning so as to have a specified in-plane distribution. This configuration regulates the light from the light exit surface 16a to have an even in-plane distribution.

As illustrated in FIGS. 3 and 4, the reflection sheet 21 is arranged so as to cover an entire area of the rear plate surface 16b of the light guide plate 16. Light that has exited the light guide plate 16 through the rear plate surface 16b is reflected toward the light exit surface 16a side (the front plate surface 16a side) by the reflection sheet 21. The reflected light then enters the light guide plate 16. The reflection sheet 21 is a sheet-like member and at least a front surface 21a thereof has color in white having high light reflectivity. The reflection sheet 21 may be made of a foamed plastic sheet such as a foamed polyethylene terephthalate sheet. The reflection sheet 21 has a substantially rectangular shape similar to the liquid crystal panel 11. End portions 211 along the long sides of the reflection sheet 21 are located outside (the LED units LU side) the long-side end surfaces (light entrance surfaces) 16c of the light guide plate 16. The long-side end portions 211 of the reflection sheet 21 are portions that cover connectors 19 that are arranged on the LED boards 18, which will be described later. In other words, the connectors 19 are arranged on a rear surface 21b side of the reflection sheet 21. For ease of description, a part of the reflection sheet 21 that corresponds to the rear plate surface 16b of the light guide plate 16 is referred to as a body portion 210.

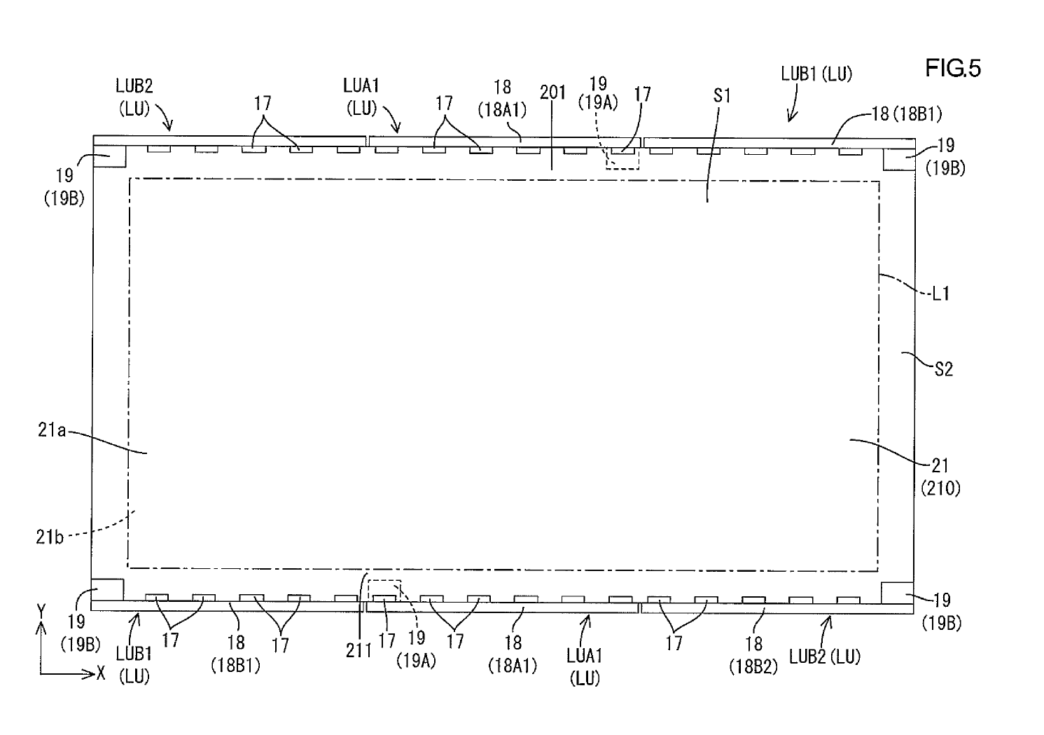

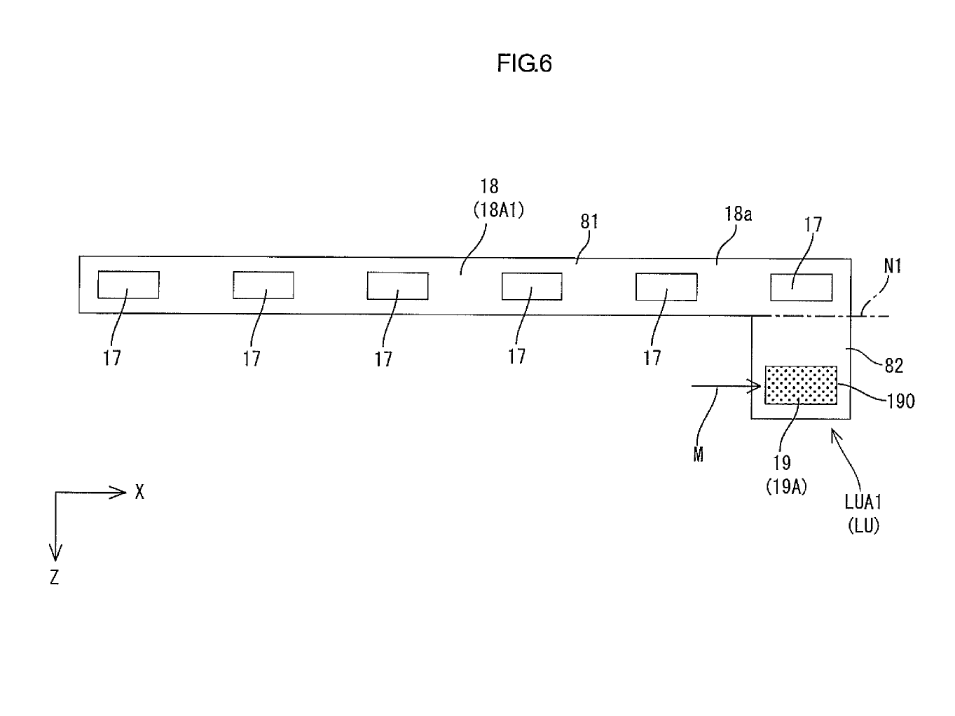

Each LED unit LU mainly includes the LEDs (LED light source) 17, the connector 19, and the LED board (light source board) 18 on which the LEDs 17 and the connector 19 are mounted. FIG. 5 is an explanatory view schematically illustrating an arrangement of the LED units LU and the reflection sheet 21. In FIG. 5, the arrangement of the LED units LU and the reflection sheet 21 when viewed from the front side is schematically illustrated. As illustrated in FIG. 5, three LED units LU are arranged in line with each other along each long-side end of the reflection sheet 21. In one of the three LED units LU per long-side end, the LED unit LU arranged between the other two LED units LU is an LED unit LUA1. The other two LED units LU are an LED unit LUB1 and an LED unit LUB2. The LED unit LUB1 is on the left side of the LED units LUA1 when the reflection sheet 12 (the light guide plate 16) is viewed from the LED unit LUA1 side. The LED unit LUB2 is on the right side of the LED unit LUA1 when the reflection sheet 12 is viewed from the LED unit LUA1 side. The LED unit LUA1 will be described with reference to FIG. 6.

FIG. 6 is a plan view of the LED unit LUA1 among the LED units LU. In FIG. 6, a configuration of the LED unit LUA1 viewed from a mount surface (plate surface) 18a side is schematically illustrated. As illustrated in FIG. 6, each LED unit LUA1 includes the LEDs 17, an LED board 18A1, and a connector 19A. The LED board 18A1 includes a main body 81 and an extension portion 82. The connector 19A is mounted on the extension portion 82.

Each LED (Light Emitting Diode) 17 includes an LED chip arranged on a board fixed on the LED board 18 and sealed with resin. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light from the LED chip. Thus, overall color of light emitted by the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting-surface that is opposite to a surface thereof facing the mount surface 18a of the LED board 18A1. Namely, the LED 17 is a top-surface-emitting type LED.

As illustrated in FIGS. 3 and 4, the LED board 18A1 has an elongated plate-like shape and extends in the long-side direction of the light guide plate 16 (the X-axis direction, the long-side direction of the light entrance surface 16c). The LED board 18A1 is arranged in a space provided between the frame 13 and the chassis 14 such that the plate surface 18a of the LED board 18A1 is parallel to the X-Z plane. In other words, the plate surface 18a is aligned parallel to the light entrance surface 16c of the light guide plate 16. The LEDs 17 described earlier are mounted on the plate surface (the plate surface facing the light guide plate 16) 18a of the LED board 18A1 on its front side. Namely, the plate surface 18a is the mount surface 18a. The LEDs 17 are arranged in a part of the mount surface 18a that corresponds to the main body 81 of the LED board 18A. Specifically, the LEDs 17 are arranged in line along the long-side direction (X-axis direction) of the main body 81 with predetermined distances therebetween. The distances between the adjacent LEDs 17 (an arrangement pattern of the LEDs 17) on the LED board 18A1 are substantially equal. An arrangement direction of the LEDs 17 is parallel to the long-side direction of the LED board 18A1 (the X-axis direction). A metal-film trace (not illustrated), such as a copper-foil trace, is formed on the mount surface 18a of the LED board 18A. The metal-film trace mainly extends in the X-axis direction and crosses over the LEDs 17 to connect the adjacent LEDs 17 in series. A base of the LED board 18A1 is made of metal such as aluminum. The trace is formed on a surface of the base of the LED board 18A1 with an insulating layer in between. A solder resist layer is formed on the trace to protect the trace. The trace is formed by a known printed wiring technology. A material used for the base of the LED board 18A1 may be an insulating material such as ceramic.

As illustrated in FIG. 6, for ease of description, the LED board 18A1 is divided into two portions, that is, the longitudinal main body 81 and the extension portion 82. The extension portion 82 extends (the lower side in FIG. 6, the rear side of the lighting device 12) from one end of the main body 81 toward the outside. In FIG. 6, a portion above boundary line (a chain line) N1 is the main body 81 and a portion below boundary line N1 is the extension portion 82. Each LED 17 is arranged on the main body 81. The connector 19A is arranged on the extension portion 82. The connector 19A is configured to relay an electric power supply to each LED 17. The trace that connects the LEDs 17 in series has ends on an anode-side (positive side) and a cathode-side (negative side) on the extension portion 82. The LEDs 17 are arranged on an upper side (the front side of the liquid crystal display device 10) of the connector 19A in FIG. 6.

The connector 19A includes a housing 190 and two terminals (not illustrated) as the main components. The housing 190 is made of synthetic resin having an insulation property. The terminals are arranged inside the housing 190. The housing 190 has a substantially cuboid external shape. Specifically, the housing 190 has a box-like shape that is open to one side. A counterpart connector (not illustrated) is inserted in a hollow of the housing 190. In this embodiment, the counterpart connector is inserted in the hollow in a direction indicated by arrow M in FIG. 6. The direction indicated by arrow M corresponds to the X-axis direction. The counterpart connector is arranged at an end portion of a predetermined electric wire.

One of the terminals is on the power-source side and electrically connected to a drive-control circuit (included in the power board PWB in this embodiment) via the counterpart connector. The drive control circuit is configured to supply electric power and send signals that are necessary for turning on the LEDs 17. A rear end of the power-source side terminal is connected to the end of the trace on the anode side. The other one of the terminals is on the ground (GND) side and grounded via the counterpart connector. A rear end of the ground side terminal is connected to the end of the trace on the cathode side.

The LED unit LUA1 is fixed to a heat dissipation member 20, which will be described later, and arranged in a specified portion of the lighting device 12. As illustrated in FIGS. 4 and 5, the connector 19A included in the LED unit LUA1 is arranged on the rear surface 21b side of the reflection sheet 21. Specifically, the connector 19A is located more to the rear (the lower side in FIG. 4) than the rear plate surface 16b of the light guide plate 16 and covered with the end portion 211 of the reflection sheet 21 from an upper side (the front side) of the connector 19A. The end portion 211 of the reflection sheet 21 is located between the LEDs 17 mounted on the LED board 18A1 and the connector 19A. As illustrated in FIG. 4, the LED 17 on the LED board 18A is opposite the end surface 16c. A display area S1 is an inner area of the liquid crystal panel 11. As illustrated in FIG. 5, the display area S1 is located in front of (a light emitting direction in the LED 17) the LED unit LUA1 when the liquid crystal display device 10 is viewed from the front side. An inner area defined by boundary line (a chain-line) L1 in FIG. 5 corresponds to the display area S1 of the liquid crystal panel (the liquid crystal display device 10). An area outside boundary line L1 is an area that corresponds to a non-display area S2 having a frame-like shape that surrounds the display area S1. Boundary line L1 corresponds to a position of an inner peripheral edge of the frame 13.

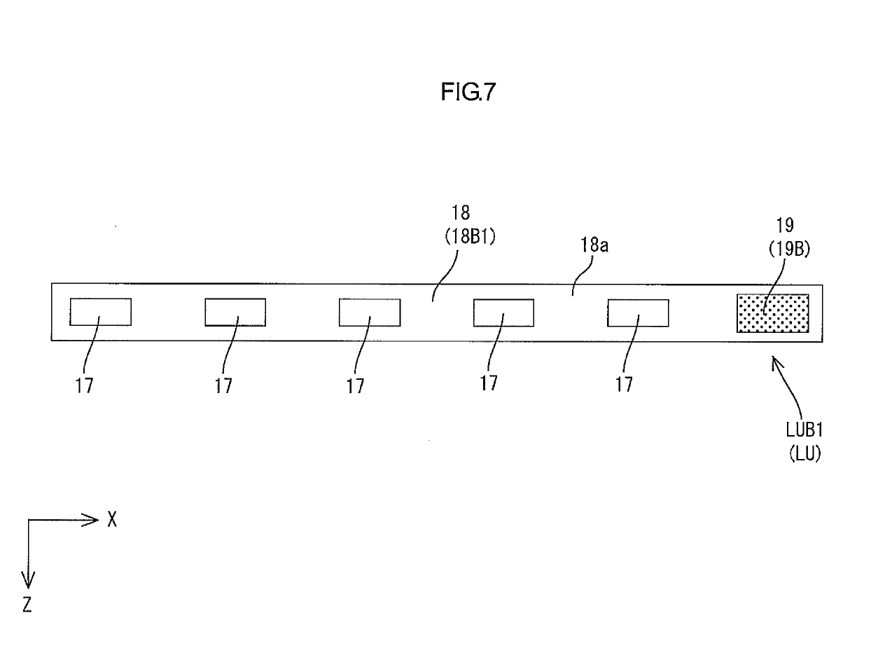

The LED units LUB1 will be described with reference to FIG. 7, mainly. FIG. 7 is a plan view of the LED unit LUB1 among the LED units LU. In FIG. 7, a configuration of the LED unit LUB1 viewed from the mount surface (plate surface) 18a side is schematically illustrated. Unlike the LED units LUA1, each LED unit LUB1 includes an LED board 18B1. The LED board 18B1 has a longitudinal shape. The LEDs 17 are mounted on the LED board 18B1 in line at predetermined intervals (distances equal to the distances between the LEDs 17 in the LED unit LUA1). Similar to the LED unit LUA1, the LEDs 17 are connected to each other in series by a predetermined trace. A connector 19B that is configured to relay an electric power supply to each LED 17 is arranged at one end (the right end in FIG. 7) of the LED board 18B1. The connector 19B is arranged in line together with the LEDs 17 on the LED board 18B1. The LEDs 17 and the connector 19B that are included in the LED unit LUB1 are opposite the end surface 16c of the light guide plate 16. As illustrated in FIGS. 4 and 5, each connector 19B is arranged on the front side of the reflection sheet 21. Unlike the connectors 19A among the LED units LUA1, the connectors 19B are not covered with the end portions 211 of the reflection sheet 21. The non-display area S2 is located in front (the light emitting direction in the LED 17) of the connector 19B on each LED unit LUB1 when the liquid crystal display device 10 is viewed from the front side. The basic configuration of the LED unit LUB1 is similar to that of the LED unit LUA1 except for the shape of the LED board 18B1 and the arrangement position of the connector 19B on the LED board 18B1. The LED unit LUB1 is supported by the heat dissipation member 20, similar to the LED unit LUA1.

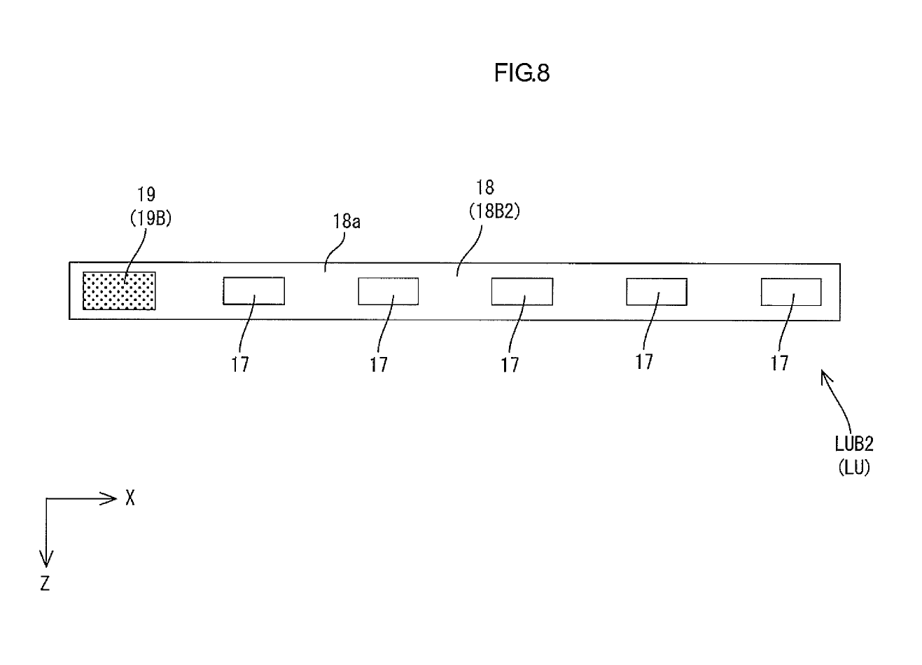

The LED units LUB2 will be described with reference to FIG. 8, mainly. FIG. 8 is a plan view of the LED unit LUB2 among the LED units LU. In FIG. 8, a configuration of the LED unit LUB2 viewed from the mount surface (plate surface) 18a side is schematically illustrated. Each LED unit LUB2 includes an LED board B2 having a longitudinal shape similar to that of the LED unit LUB2. The LEDs 17 are mounted on the LED board 18B2 in line at predetermined intervals (distances equal to the distances between the LEDs 17 in the LED unit LUA1). Similar to the LED unit LUA1, the LEDs 17 are connected to each other in series by a predetermined trace. The connector 19B, which is configured to relay an electric power supply to each LED 17, is arranged at one end (the left end in FIG. 8) of the LED board 18B2. The connector 19B is arranged in line together with the LEDs 17 on the LED board 18B2. The LEDs 17 and the connector 19B that are included in the LED unit LUB2 are opposite the end surface 16c of the light guide plate 16. As illustrated in FIG. 5, the connectors 19B are arranged on the front side of the reflection sheet 21. Unlike the connectors 19A on the LED unit LUA1, the connectors 19B are not covered with the end portions 211 of the reflection sheet 21. The display area S2 is located in front (the light emitting direction in the LED 17) of the connector 19B on each the LED unit LUB2 when the liquid crystal display device 10 is viewed from the front side. The basic configuration of the LED unit LUB2 is similar to that of the LED unit LUA1 except for the shape of the LED board 18B2 and the arrangement position of the connector 19B on the LED board 18B1. The LED unit LUB2 is supported by the heat dissipation member 20, similar to the LED unit LUA1.

A distance between the adjacent LEDs 17 on the adjacent LED units LUA1 and LUB1 is the same as distances between the LEDs 17 on the LED unit LUA1. Further, a distance between the adjacent LEDs 17 on the adjacent LED units LUA1 and LUB2 is the same as the distances between the LEDs 17 in the LED unit LUA1. Therefore, all of the LEDs 17 opposite each end surface 16c of the light guide plate 16 are arranged in line at equal intervals (equal distances) over the multiple LED units LU.

The heat dissipation members (light source holding member) 20 hold all of the above three types of LED units LUA1, LUB1, and LUB2. Each heat dissipation member 20 is made of metal having high thermal conductivity, such as aluminum. The heat dissipation member 20 includes an attachment portion 20a and a heat dissipation portion 20b. The attachment portion 20a and the heat dissipation portion 20b each have an elongated plate-like shape. The LED boards 18 are mounted on each attachment portion 20a. The heat dissipation portion 20b is in surface-contact with a plate surface of the chassis 14. The attachment portion 20a and the heat dissipation portion 20b form an angle therebetween so as to have an L-like shape in a cross-section. The plate-like attachment portion 20a is parallel to the plate surface of the LED board 18 and the light entrance surface 16c of the light guide plate 16. A long-side direction, a short-side direction, and a thickness direction of the attachment portion 20a correspond to the X-axis direction, the Z-axis direction, and the Y-axis direction, respectively. The LED boards 18 are mounted on an inner surface of the attachment portion 20a, that is, a plate surface of the attachment portion 20a on the light guide plate 16 side. The attachment portion 20a has the long-side dimension that is substantially equal to a sum of the long-side dimensions of the three LED boards 18. The short-side dimension of the attachment portion 20a is larger than a short-side dimension of each LED board 18 to some extent. An outer surface of the attachment portion 20a (a plate surface of the attachment portion 20a opposite the surface on which the LED boards 18 are mounted) is opposite a first projection 31 of the frame 13, which will be described later. The attachment portion 20a is arranged between the first projection 31 of the frame 13 and the light guide plate 16. The attachment portion 20a is in surface-contact with the first projection 31. If the LEDs 17 are turned on and heat is generated by the LEDs 17, the heat is transferred through the LED board 18 and the attachment portion 20a to the frame 13, which includes the first projection 31. The heat thus can be released to the outside. The attachment portion 20a rises from an inner edge (an end portion on the LEDs 17 side) of the heat dissipation portion 20b toward the front side (toward the frame 13) in the Z-axis direction. The LED units LU (LUA1, LUB1, and LUB2) are fixed to the attachment portion 20a of the heat dissipation member 20, respectively, with fixing means such as screws.

The plate-like heat dissipation portion 20b is parallel to the plate surface of the chassis 14. A long-side direction, a short-side direction, and a thickness direction of the heat dissipation portion 20b correspond to the X-axis direction, the Y-axis direction, and the Z-axis direction, respectively. An overall rear surface of the heat dissipation portion 20b (a plate surface facing the chassis 14) is in surface-contact with the plate surface of the chassis 14. If the LEDs 17 are turned on and heat is generated by the LEDs 17, the heat is transferred through the LED boards 18, the attachment portion 20a, and the heat dissipation portion 20b to the chassis 14. The heat is thus released to the outside. The heat dissipation portion 20b has a long-side dimension that is substantially the same as that of the attachment portion 20b. A front plate surface of the heat dissipation portion 20b (a plate surface opposite the plane-contact surface with the chassis 14) is opposite the first projection 31 of the frame 13, which will be described later. The heat dissipation portion 20b is arranged between the first projection 31 of the frame 13 and the chassis 14. The heat dissipation portion 20b is in surface-contact with not only the chassis 14 but also the first projection 31. Therefore, heat from the LEDs 17 can be transferred to the frame 13. The heat dissipation portion 20b is attached to the first projection 31 with screw members SM1. Therefore, the heat dissipation portion 20b includes through holes 20b1 through which the screw members SM1 are passed. The heat dissipation portion 20b extends outwardly from a rear end of the attachment portion 20a in the Y-axis direction. In other words, the heat dissipation portion 20b extends from an end of the attachment portion 20a on the chassis 14 side toward a side opposite from the light guide plate 16.

The frame 13 has a frame-like shape as a whole that surrounds an external portion (non-display area) of the display surface 11c of the liquid crystal panel 11. The frame 13 is made of metal having high thermal conductivity, such as aluminum, and may be formed into a predetermined shape using a die. The frame 13 includes a front portion 13a having a frame-like shape and a peripheral walls 13b. The front portion 13a is arranged on the front side of the liquid crystal display unit LDU (the liquid crystal display device 10). The peripheral walls 13b constitute a peripheral portion of the liquid crystal display unit LDU (the liquid crystal display device 10). The peripheral walls 13b extend from outer peripheral edges of the front portion 13a toward the rear side so as to form a frame-like shape (a hollow shape) as a whole.

The front portion 13a has a landscape rectangular shape when viewed from the front side. The display surface 11c (the display area) is exposed to the outside from an inner opening defined by the frame-like front portion 13a. The first projections 31, a second projection 32, and a third projection 33 are arranged on a rear surface of the front portion 13a in this sequence from an outer edge of the front portion 13a toward an inner edge of the front portion 13a. The front portion 13a includes a first groove 35 in the rear surface thereof. An extended end (edge portion) of the attachment portion 20a of the heat dissipation member 20 is fitted in the first groove 35 so that the heat dissipation member 20 can be positioned with respect to the frame 13. The first groove 35 is formed between the first projection 31 and the second projection 32.

The first projections 31 are portions to which the heat dissipation members 20 are directly fixed. Each first projection 31 projects toward the rear side (the chassis 14 side) and extends along a long-side direction of the front portion 13a. The first projection 31 projects more than other projections 32 and 33 toward the rear side. In this embodiment, each first projection 31 is arranged along each long-side end of the front portion 13a. Each heat dissipation member 20 is fixed to each first projection 31. The first projection 31 includes a second groove 34. The second groove 34 is open to the rear side and extends along a long-side direction of the first projection 31. The second groove 34 is provided as a screw receiving portion. The screw members SM1 and screw members SM2 are inserted and screwed into the second groove 34 to fix the heat dissipation portion 20 and the chassis 14 to the first projection 31.

The second projection 32 is a portion that presses the light guide plate 16 to the chassis 14. A projected end of the second projection 32 is in contact with a peripheral portion of the front plate surface 16a of the light guide plate 16. The second projection 32 has a frame-like shape as a whole when the frame 13 is viewed from the rear side. A shock absorber 35 is arranged on an inner side (an inner peripheral side) of the second projection 32. The shock absorber 35 is an elastic member such as rubber and has a light blocking property. With the shock absorber 35, a contact shock that may generate between the second projection 32 and edges of the liquid crystal panel 11 can be reduced.

The third projection 33 is a portion that presses the liquid crystal panel 11 toward the chassis 14 (toward the light guide plate 16). A projected end of the third projection 33 is in contact with the peripheral portion (the non-display area) of the front plate surface (the display surface 11c of the CF substrate 11a) of the liquid crystal panel 11. The third projection 33 extends less than the other projections 31 and 32 and has a frame-like shape as a whole when the frame 13 is viewed from the rear side. A shock absorber 37 is arranged along the projected end of the third projection 33. The shock absorber 37 is made of the same material as that of the shock absorber 35. Namely, the third projection 33 is in contact with the peripheral portion of the liquid crystal panel 11 with the shock absorber 37 in between.

The peripheral wall 13b has a substantially rectangular hollow shape as a whole. The peripheral wall 13b surrounds an entire periphery of a laminated material that includes the liquid crystal panel 11, the optical member 15, the light guide plate 16, and the reflection sheet 21. The peripheral wall 13b also surrounds the chassis 14 such that an inner area of the peripheral wall 13b is in contact with a peripheral portion of the chassis 14.

The chassis 14 is a plate-like member having a landscape rectangular shape as a whole, which has a similar configuration to the liquid crystal panel 11. The chassis 14 is arranged on the rear side of the liquid crystal display unit LDU (the liquid crystal display device 10) so as to cover the rear plate surface 16b of the light guide plate 16 from the rear side. The chassis 14 includes a chassis body 14a having a rectangular plate-like shape and peripheral portions 14b extending along long ends of the chassis body 14a. The chassis body 14a is a portion that is arranged on the rear plate surface 16b of the light guide plate 16 with the reflection sheet 21 in between. The chassis body 14 constitutes a large part of the chassis 14. The chassis body 14a is in close-contact with the rear plate surface 16b of the light guide plate 16 with the reflection sheet 21 in between. On the other hand, each peripheral portion 14b has a convex shape that protrudes from the chassis body 14a toward a rear side of the chassis body 14a. The peripheral portion 14 has a shallow tray shape along the long-side direction of the chassis 14 as a whole. As illustrated in FIG. 4, the heat dissipation member 20 and the LED unit LU that are fixed to the first projection 31 are arranged in the peripheral portion 14b.

Each long end of the chassis 14 (the peripheral portion 14b) includes two kinds of holes: larger holes 14b1 and smaller holes 14b2. The larger holes 14b1 are for the screw members SM1 that are used to fix the heat dissipation member 20 to the first projection 31. Each hole 14b1 is provided so that an end portion (an head portion) of the screw member SM1 is uncovered. The hole 14b1 is larger than an end portion (an head portion) of the screw member SM1. On the other hand, the smaller holes 14b2 are for the screw members SM2 that are used to fix the chassis 14 to the frame 13. The screw members SM2 are inserted in the respective holes 14b2 and the respective through holes 20b2 of the heat dissipation member 20 (the heat dissipation portion 20b). The screw members SM2 are screwed into the second groove 34 while inserted in the respective through holes 20b2. Thus, the chassis 14 is fixed to the chassis 13. Accordingly, the laminated material including the liquid crystal panel 11, the optical member 15, the light guide plate 16, and the reflection sheet 21 and the LED units LU that are arranged around the periphery of the laminated material are held between the frame 13 and the chassis 14. Similar to the frame 13, the chassis 14 is made of metal having high thermal conductivity, such as aluminum, and may be formed into a predetermined shape using a die.

The components of the liquid crystal display device 10 (the liquid crystal display unit LDU) described earlier are assembled according to the following procedures. First, the frame 13 is set on a workbench (not illustrated). The frame 13 is on the workbench with the front surface of the frame 13 face down and the rear surface of the frame 13 face up. Then, the liquid crystal panel 11 is attached to an upper side (the rear surface of the frame 13) of the frame 13 on the workbench. The liquid crystal panel 11 is placed on the frame 13 with the CF substrate 11a face down and the array substrate 11b face up. The CF substrate 11a of the liquid crystal panel 11 is on the third projection 33 of the frame 13 with the shock absorber 37 in between. After the liquid crystal panel 11 is attached to the frame 13, the optical member 15 is placed on the rear surface (the array substrate 11) of the liquid crystal panel 11.

Next, the heat dissipation members 20 including the LED units LU is fixed to the first projections 31 of the frame 13 with the screw members SM1. Specifically, the heat dissipation member 20 is placed on the first projection 31 with the attachment portion 20a face up and the heat dissipation portion 20b face down. The extended end (edge portion) of the attachment portion 20a is fitted in the first groove 35 so that the heat dissipation member 20 can be roughly positioned with respect to the frame 13. The heat dissipation member 20 is fastened up to the first projection 31 with the screw members SM1 while the heat dissipation member 20 is on the first projection 31.

Next, the light guide plate 16 is placed on the optical member 15 with the front plate surface 16a of the light guide plate 16 face down and the rear plate surface 16b of the light guide plate 16 face up. The front plate surface 16a is the light exit surface 16a. The light guide plate 16 is placed on the frame 13 while the peripheral portion of the front plate surface 16a is in contact with the second projection 32 of the frame 13. The light guide plate 16 is positioned with respect to the frame 13 such that a gap (a distance) between each of the end surfaces (the light entrance surfaces) 16c and the corresponding LED unit LU is equal to a predetermined distance. The connector 19A of the LED unit LUA1 is located outside the rear plate surface 16b of the light guide plate 16. The connectors 19B of the LED unit LUB1 and LUB2 are opposite the end surface 16c of the light guide plate 16.

Next, the reflection sheet 21 is attached to the light guide plate 16. The reflection sheet 21 is placed on the light guide plate 16 such that the front surface 21a of the reflection sheet 21 is in contact with the rear plate surface 16b of the light guide plate 16. The end portions 211 on the long-side ends of the reflection sheet 21 are located outside the respective plate surfaces 16b of the light guide plate 16. The end portions 211 are arranged between the connectors 19A of the LED units LUA1 and the LEDs 17. During assembly, the connectors 19A of the LED units LUA1 are located on the upper side of the reflection sheet 21. Next, the chassis 14 is attached to the frame 13 while the chassis 14 is on the plate surface 16b of the light guide plate 16 with the reflection sheet 21 in between. The chassis 14 is fixed to the first projections 31 of the frame 13 with the screw members SM2. Thus, each component of the liquid crystal display unit LDU is assembled.

The stand fitting members STA and the boards PWB, MB, and CTB are attached to the rear side of the liquid crystal display unit LDU. The stand ST and the cover CV are then attached to the liquid crystal display unit LDU. Thus, the liquid crystal display device 10 and the television device TV are produced.

When the liquid crystal display device 10 is turned on and power is supplied from the power source board PWB, signals are sent from the control board CTB to the liquid crystal panel 11 and operation of the liquid crystal panel 11 is controlled. Furthermore, the LEDs 17 included in the lighting device 12 are driven. When the LEDs 17 are driven, light is emitted by the LEDs 17. The light enters the light guide plate 16 through the light entrance surface 16c. The incident light is reflected by the reflection sheet 21 that is laid on the rear side of the light guide plate 16. The light passes through the light guide plate 16 and exits the light guide plate 16 through the front plate surface (the light exit surface) 16a toward the optical member 15. The light from the optical member 15 is formed into planar light that spreads out at a substantially even distribution when exits from the optical member 15. The planar light reaches the rear surface of the liquid crystal panel 11. The liquid crystal panel 11 displays images on the display surface 11c using the planer light.

In the lighting device 12 of this embodiment, as illustrated in FIGS. 4 and 5, each LED unit LUA1 is arranged opposite a substantially middle area of each end surface 16c of the light guide plate 16. In front of the connector 19A included in the LED unit LUA1 (a light output direction in the LED 17), a part of the light exit surface 16a through which light exits the light guide plate 16 toward the display area S1 of the liquid crystal panel 10 (liquid crystal panel 11) is located. The part of the light exit surface 16a is an inner area defined by the inner peripheral portion of the frame 13. When the lighting device 12 (the liquid crystal display device 10) is viewed from the front side, the connectors 19A are covered with the end portions 211 of the reflection sheet 21. Because light emitted by the LEDs 17 of the LED units LU is less likely to reach the connector 19A (the housings 190), the light is less likely to be absorbed by the connectors 19A (the housings 190). Further, an amount of light that enters the light guide plate 16 from the end surface (light entrance surface) 16c is less likely to be reduced. Namely, uneven brightness due to the connector 19A is less likely to occur in the planar light emitted from the lighting device 12.

Only the LED unit LUA1 among the LED units LUA1, LUB1, and LUB2 of this embodiment corresponds to “a light source unit” according to this invention. In this embodiment, the connectors 19B included in the LED units LUB1 and LUB2 are opposite the end surfaces 16c of the light guide plate 16. In front of each connector 19B (the light emitting direction in the LED 17), apart of the light guide plate 16 that corresponds to the non-display area S1, which is in the outer area of the display area S1, is located. Therefore, even if the connectors 19B are not covered with the end portions 211 of the reflection sheet 21, the connectors 19B does not substantially cause uneven brightness in the lighting device 12.

In the lighting device 12 of this embodiment, one of the LEDs 17 is arranged straight above (i.e. the front side of the lighting device 12) the connector 19A of the LED unit LUA1. Specifically, since the connector 19A is arranged on the extension portion 82 that is located lower (the rear side) than the rear plate surface 16b of the light guide plate 16, space for the LED 17 can be provided at a part of the main body 81 straight above the extension portion 82. With this configuration, a distance between the adjacent LEDs 17 on the adjacent LED units LUA1 and LUB1 can be set as same as the distance between the LEDs 17 on the LED unit LUA1. Further, the distance between the adjacent LEDs 17 on the adjacent LED units LUA1 and LUB1 can be set smaller than a size (a width) of the connector 19A. Therefore, light emitted by the LEDs 17 falls on evenly across the end surface 16c of the light guide plate 16. As a result, a decrease in brightness due to the locations of the connectors 19A is less likely to occur.

### Second Embodiment

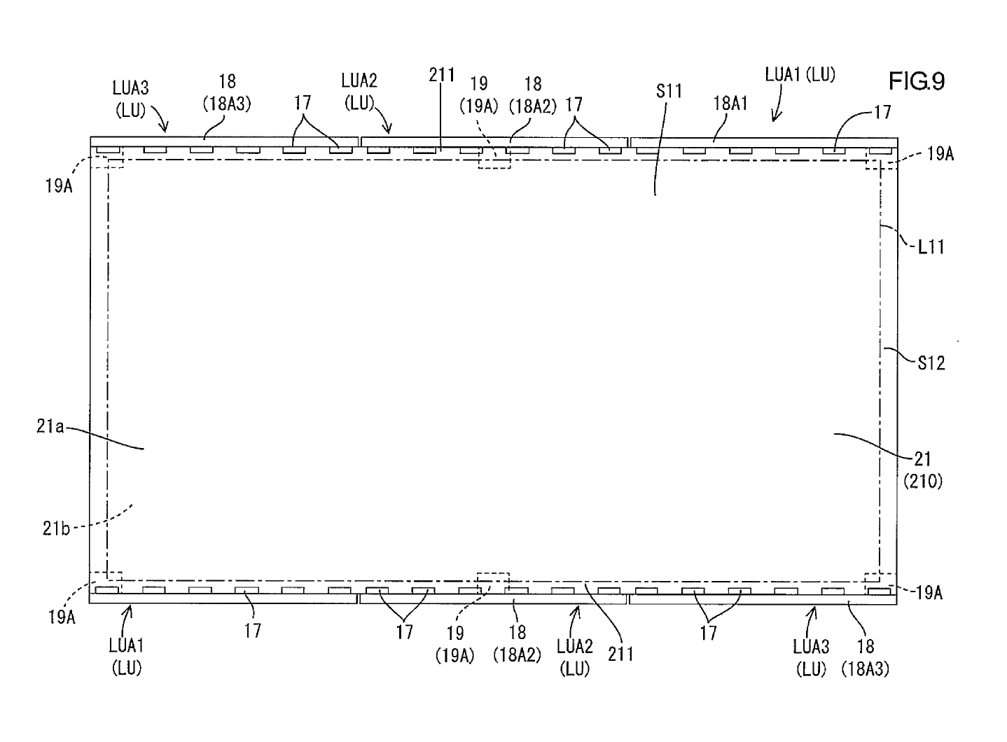

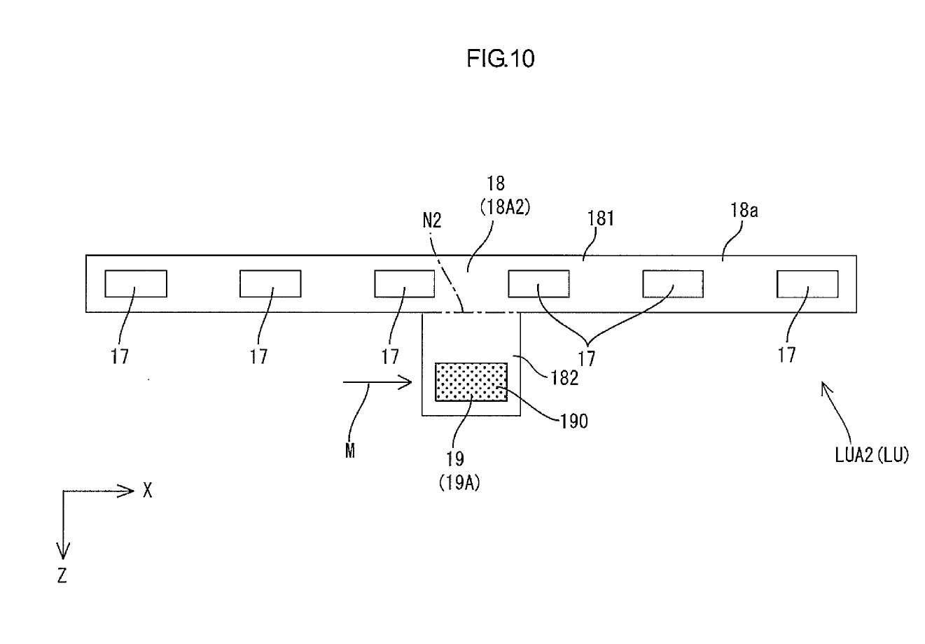

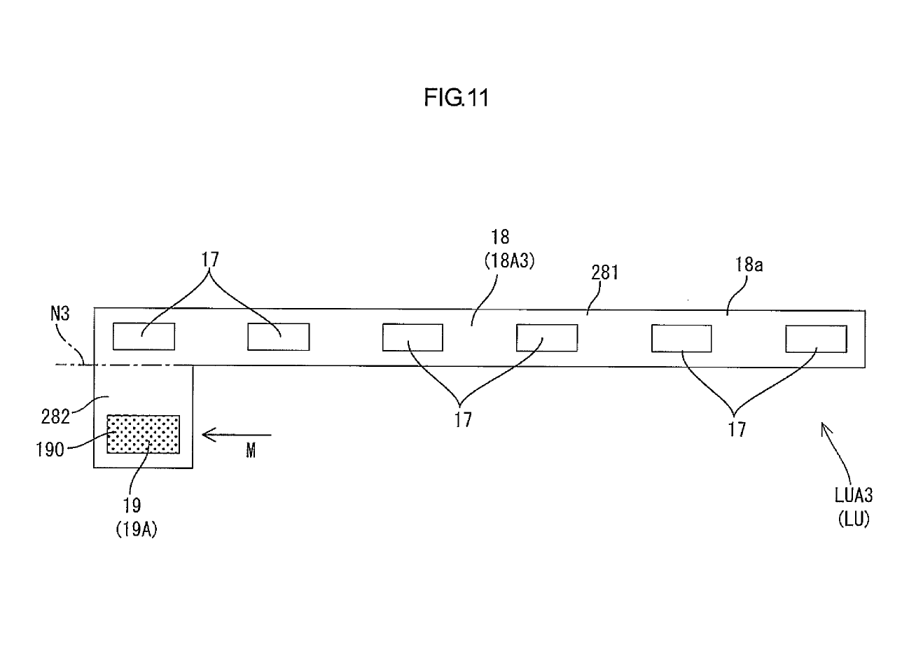

A second embodiment according to this invention will be described with reference to FIGS. 9 to 11. The same components will be indicated by the same symbols as the first embodiment and will not be described. FIG. 9 is an explanatory view schematically illustrating an arrangement of the LED units LU and the reflection sheet 21 included in a lighting device according to the second embodiment. FIG. 10 is a plan view of an LED unit LUA2. FIG. 11 is a plan view of an LED unit LUA3. The basic configuration of the lighting device of this embodiment is similar to that of the first embodiment. However, configurations (types) of the LED units LU included in the lighting device of this embodiment are different from those of the first embodiment. The LED units LU included in this embodiment will be mainly described.

As illustrated in FIG. 9, in the lighting device according to this embodiment, similar to the first embodiment, three LED units LU are arranged along each long-side end surface 16c (see the first embodiment) of the light guide plate 16. The three LED units LU are arranged in line and opposite each end surface 16c. Among the three LED units LU, the LED unit LU arranged between the other LED units LU is an LED unit LUA2. As illustrated in FIG. 9, the LED units LUA1, which are included in the first embodiment, are arranged on the left sides of the respective LED units LUA2 when the reflection sheet 21 (the light guide plate 16) is viewed from the respective LED unit LUA2 sides. LED units LUA3 are arranged on the right sides of the respective LED units LUA3 when the reflection sheet 21 (the light guide plate 16) is viewed from the respective LED unit LUA3 sides. Each of the three types of LED units LUA1, LUA2, and LUA3 included in this embodiment includes the connector 19A. The connector 19A are arranged lower than the rear plate surface 16c of the light guide plate 16 and are covered with the end portions 211 of the reflection sheet 21.

As illustrated in FIG. 10, the LED unit LUA2 includes the LEDs 17, an LED board 18A2, and the connector 19A as its main components. As illustrated in FIG. 10, the LED board 18A2 is divided into a longitudinal main body 181 and an extension portion 182 for ease of description. The extension portion 182 extends from about a middle area in a longitudinal direction of the main body 181 toward the outside (the lower side in FIG. 10, the rear side of the lighting device). In FIG. 10, the main body 181 is a portion above boundary line (a chain line) N2 and the extension portion 182 is a portion below boundary line N2. The LEDs 17 are arranged on the main body 181. The connector 19A that is configured to relay an electric power supply to each LED 17 is arranged on the extension portion 182. The LEDs 17 on the LED board 18A2 are connected in series via a trace (not illustrated) made of the same material as that of the first embodiment, such as copper foil. Ends of the trace on an anode side (positive side) and a cathode side (negative side) are formed on the extension portion 182 and connected to two terminals housed in the connector 19A. The LED unit LUA2 corresponds to “the light source unit” according to this invention.

The LED unit LUA3 includes the LEDs 17, the connector 19A, and an LED board 18A3 as its main components. As illustrated in FIG. 11, the LED board 18A3 is divided into a longitudinal main body 281 and an extension portion 282 for ease of description. The extension portion 282 extends from an end portion of the main body 281 toward the outside (the lower side in FIG. 11, the rear side of the lighting device). In FIG. 11, the main body 281 is a portion above boundary line (a chain line) N3 and the extension portion 282 is a portion below boundary line N3. The LEDs 17 are arranged on the main body 281. The connector 19A that is configured to relay an electric power supply to each LED 17 is arranged on the extension portion 282. The LEDs 17 on the LED board 18A3 are connected in series via a trace (not illustrated) made of the same material as that of the first embodiment, such as copper foil. An end of the trace on an anode side (positive side) and an end of the trace on a cathode side (negative side) are formed on the extension portion 282 and connected to two terminals housed in the connector 19A. The LED unit LUA3 corresponds to “the light source unit” according to this invention.

In the lighting device according to this embodiment, all of the connectors 19A of the LED units LU are covered with the end portions 211 of the reflection sheet 21. The connectors 19A on the respective three LED units LU (LUA1, LUA2, and LUA3) that are arranged in line along each end surface 16c are behind the rear surface 21b of the reflection sheet 21. As described the above, uneven brightness of the lighting device due to the connectors may be reduced by covering all connectors 19A with the end portions 211 of the reflection sheet 21.

A display area S11 is located in front (the light emitting direction of the LED 17) of the LED unit LUA2 when a liquid crystal display device that includes the lighting device of this embodiment is viewed from the front side. The display area S11 is an inner area of the liquid crystal panel. Specifically, as illustrated in FIG. 9, an area defined by boundary line (a chain line) L11 corresponds to the display area S11 of the liquid crystal panel (the liquid crystal display device). In this embodiment, the display area S11 is slightly larger in long-side and short-side directions in comparison to the display area S1 of the first embodiment. An outer area of boundary line L11 is a non-display area S12 having a frame-like shape that surrounds the display area S11. When the liquid crystal display device is viewed from the front side, parts of the display area S11 are located in front (the light emitting direction of the LED 17) of the LED units LUA1 and LUA2.

In the lighting device of this embodiment, all of the connectors 19A on the LED units LU are arranged outside (a rear side of the liquid crystal display device) the rear plate surface 16c of the light guide plate 16. Therefore, a distance between the end surface 16c of the light guide plate 16 and the LEDs 17 of the LED units LU can be set smaller. With this configuration, light from the LEDs 17 enters the light guide plate 16 efficiently through the end surface 16c. All of the connectors 19A on the LED units LU may be arranged outside (the rear side of the liquid crystal display device) the rear plate surface 16c of the light guide plate 16 such as in this embodiment.

### Third Embodiment

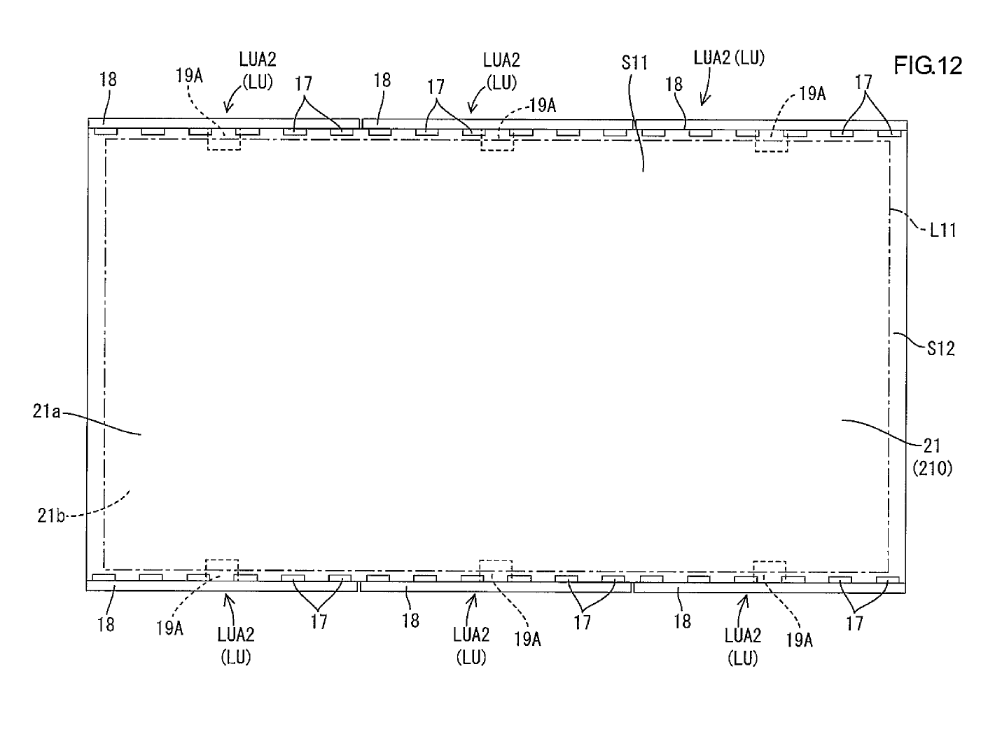

A third embodiment according to this invention will be described with reference to FIG. 12. FIG. 12 is an explanatory view schematically illustrating an arrangement of the LED unit LU and the reflection sheet 21 included in a lighting device in the third embodiment. The basic configuration of the lighting device of this embodiment is the same as that in the first embodiment. However, in the lighting device according to this embodiment, all of the LED units have the same structure (a type). Hereinafter, the LED units LU included in this embodiment will be mainly described.

As illustrated in FIG. 12, similar to the first embodiment, three LED units LU are arranged along each long-side end surface 16c (see the first embodiment) of the light guide plate 16 in the lighting device of this embodiment. The three LED units LU are arranged in line and opposite each end surface 16c. The in-line three LED units LU are all the same LED units LUA2 (refers to the second embodiment). Six LED units LUA2 are used in this embodiment. The connectors 19A included in the respective six LED units LUA2 are arranged more to the lower side than the rear plate surface 16c of the light guide plate 16 and covered with the end portions 211 of the reflection sheet 21.

All of the LED units LU (LUA2) included in the lighting device of this embodiment have the same structure. Therefore, only one type of the LED units LU needs to be prepared although the multiple LED units LU are combined and used in the lighting device according to this embodiment. Thus, the production cost of the lighting device (the LED unit) can be reduced. Further, efficiency in assembly of the lighting device of this embodiment improves because consideration of a sequence of the LED units (an arrangement pattern) is not required for arranging the LED units opposite the end surface 16c of the light guide plate 16.

As described earlier, all of the connectors 19A included in the LED units LU (LUA2) are covered with the end portions 211 of the reflection sheet 21 in the lighting device according to this embodiment. In other words, all of the connectors 19A are behind the rear surface 21b of the reflection sheet 21. Therefore, uneven brightness in the lighting device due to connectors may be reduced by covering all of the connectors 19A with the end portions 211 of the reflection sheet 21.

In the lighting device of this embodiment, each connector 19A included in each of the LED units LU (LUA2) is arranged outside (the rear of the liquid crystal display device) the rear surface 16c of the light guide plate 16. Therefore, the distance between the end surface 16c of the light guide plate 16 and the LEDs 17 included in the LED units LU can be set smaller. Accordingly, light from the LEDs 17 enters the light guide plate 16 efficiently through the end surface 16c. Therefore, as described in this embodiment, the connectors 19A included in all of the LED units LU (LUA2) may be arranged outside (the rear of the liquid crystal display device) the rear surface 16c of the light guide plate 16.

### Fourth Embodiment

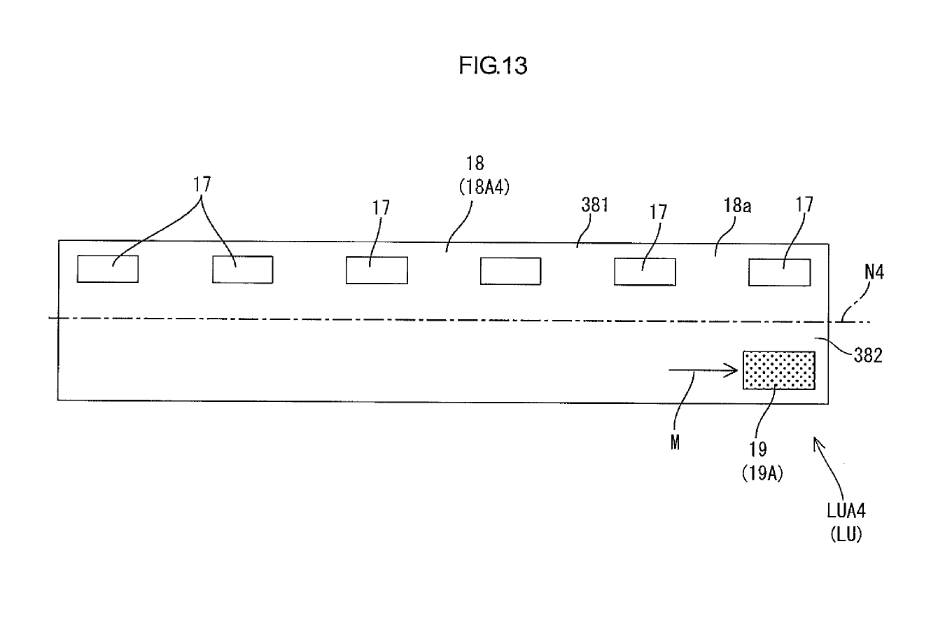

A fourth embodiment according to this invention will be described with reference to FIG. 13. FIG. 13 is a plan view of an LED unit LUA4 included in a lighting device according to the fourth embodiment. The basic configuration of the lighting device of this embodiment is the same as those in the first and second embodiments. However, a structure (a type) of the LED units included in this embodiment differs from that of the first embodiment. Hereinafter, the LED units LU included in this embodiment will be mainly described.

Similar to the first embodiment, three LED units LU are arranged along each long-side end surface 16c (refers to the first embodiment) of the light guide plate 16 in the lighting device of this embodiment. The three LED units LU are arranged in line and opposite each end surface 16c. Among the three LED units LU, the LED unit LU arranged between the other LED units LU is an LED unit LUA4. The lighting device of this embodiment has the same configuration with the lighting device 12 of the first embodiment if the LED units LUA1 in the lighting device 12 are replaced with the LED units LUA4.

As illustrated in FIG. 13, the LED unit LUA4 includes the LEDs 17, a LED board 18A4, and the connector 19A as its main components. Different from the first embodiment, each LED board 18A4 has a longitudinal shape as a whole. For ease of description, the LED board 18A4 is divided into a longitudinal main body 381 and an extension portion 382. The extension portion 382 extends from a long-side end of the body portion 381 toward the outside (the lower side in FIG. 13, the rear of the lighting device). As illustrated in FIG. 13, the extension portion 382 has a longitudinal shape as a whole in this embodiment. In FIG. 13, a portion above boundary line (a chain line) N4 is the body portion 381 and a portion below boundary line N4 is the extension portion 382. The LEDs 17 are arranged on the body portion 381. The connector 19A that is configured to relay an electric power supply to the LEDs 17 is arranged on an end portion of the longitudinal extension portion 382. The LEDs 17 on the LED board 18A4 are connected in series via a trace (not illustrated) made of the same material as that of the first embodiment, such as copper foil. An end of the trace on an anode side (positive side) and an end of the trace on a cathode side (negative side) are formed on the extension portion 382 and connected to two terminals housed in the connector 19A. Similar to the first embodiment, the connectors 19A are arranged on a rear side of the end portions 211 of the reflection sheet 21 and arranged lower than the rear surface 16c of the light guide plate 16. The LED unit LUA4 corresponds to “the light source unit” according to this invention.

As described in the LED units LUA4 included in the lighting device of this embodiment, the extension portion 382 may have a longitudinal shape same as the main body 381. The shape of the extension portion is not limited to the shape of the extension portion of the first embodiment in which the extension portion extends from a part of the main body toward the outside (the lower side). As described in this embodiment, the extension portion may extend from a whole part of the end of the main body toward the outside (the lower side).

### Other Embodiments

The scope of the invention is not limited to the above embodiments described in the above description and the drawings. The following embodiments are also included in the technical scope of this invention, for example.

(1) Three LED units LU are arranged along each end surface 16c of the light guide plate 16 in the first embodiment; however, the number of the LED units LU is not limited thereto in other embodiments. For example, four or more LED units may be arranged along each end surface 16c. A single LED unit LU may be arranged along each end surface of the light guide plate in other embodiments.

(2) The connectors 19A are directly connected to the drive control circuit (the power board PWB) via the respective counterpart connectors in the first embodiment. However, connectors may electrically connect LED units in other embodiments. In other words, connectors on LED boards of LED units may electrically connect the LED boards. In such a case, one of the LED units between adjacent LED units may include a male connector and the other LED unit may include a female connector that is connected to the male connector.

(3) The end portions 211 of the reflection sheet 21 totally cover the connectors 19A from the front side in the first embodiment. However, the end portions 211 may partially cover the connectors 19A from the front side in other embodiments unless uneven brightness does not occur in the lighting device 12.

(4) The LED units LU are arranged on two end surfaces 16c of the light guide plate 16 in the first embodiment. However, the LED units LU may be arranged along one of the end surfaces 16c in other embodiments.

(5) As illustrated in FIG. 4, a small gap is provided between the end portion 211 of the reflection sheet 21 and the connector 19A in the first embodiment. However, the end portions 211 may be directly placed on the upper sides of the connectors 19A in other embodiments. In this configuration, the end portions 211 are supported by the connectors 19A of the LED units LU from the rear surface 21B side. Therefore, deformation such as warping is less likely to occur in the end portions 211 of the reflection sheet 21.

(6) The distance between the adjacent LEDs 17 is set smaller than the width of the connector 19A (a width in a horizontal direction (the X-axis direction) in FIG. 6) in the above embodiments. However, the distance between the adjacent LEDs 17 is not limited thereto and may be determined appropriately for purposes in other embodiments.

(7) The television device TV is used as an example of the display device in the first embodiment. However, the liquid crystal display device is applicable to a mobile phone and a handheld terminal in other embodiments. Further, the display device may not include a tuner in other embodiments.

(8) The color portions of the color filters included in the liquid crystal panel 11 are in three colors R, G, B in the first embodiment. However, the color portions in four or more colors may be used in other embodiments. Further, a liquid crystal display device that displays black and white images may be used in other embodiments.

(9) TFTs are used as the switching elements of the liquid crystal display device in the first embodiment. However, switching elements other than TFTs, i.e. thin film diodes (TFD), may be used in other embodiments.

(10) The LEDs 17 are used as the light sources in the first embodiment. However, other light sources such as cold cathode tubes may be used in other embodiments.

### EXPLANATION OF SYMBOLS

10: liquid crystal display device (display device), 11: liquid crystal panel (display panel), 12: lighting device, 13: frame, 14: chassis, 15: optical member, 16: light guide plate, 16a: light exit surface (front plate surface), 16b: rear plate surface, 16c: light entrance surface, 17: LED (light source, LED light source), 18: LED board (light source board), 19: connector, 20: heat dissipation member (light source holding member), 21: reflection sheet, 211: end portion of the reflection sheet, LUD: liquid crystal display unit, LU: LED unit (light source unit), LUA1, LUA2, LUA3, LUA4: LED unit (light source unit in the this invention), LUB1, LUB2: LED unit (other light source unit)

1. A lighting device comprising:
a light guide plate being a plate-like member including:
a light entrance surface being an end surface of the plate-like member, the light entrance surface through which light enters; and
a light exit surface being a front plate surface of the plate-like member, the light exit surface through which the light in the light guide plate from the light entrance surface exits;
a reflection sheet arranged such that an end portion thereof is located more to an outer side than the light entrance surface and such that a front surface thereof is on a rear plate surface of the light guide plate; and
a light source unit including:
a plurality of light sources;
a connector configured to relay an electric power supply to the light sources; and
a light source board on which the light sources and the connector are mounted such that the light sources are opposite the light entrance surface and the connector is located on a rear side of the end portion of the reflection sheet.

2. The lighting device according to claim 1, wherein the light source board includes:
a longitudinal main body on which the light sources are mounted; and
an extension portion extending outwardly from the main body and including the connector mounted thereon.

3. The lighting device according to claim 1, wherein the light source unit includes a plurality of light source units, the light source units being arranged in line along the light entrance surface.

4. The lighting device according to claim 1, wherein the light source units have a same structure.

5. The lighting device according to claim 2, wherein the extension portion is arranged about an end area in a longitudinal direction of the body portion.

6. The lighting device according to claim 2, wherein the extension portion is arranged about an inner area in a longitudinal direction of the body portion.

7. The lighting device according to claim 1, wherein the light sources are LED light sources.

8. A display device comprising:
the lighting device according to claim 1; and
a display panel configured to display using light from the lighting device.

9. The display device according to claim 8, wherein the display panel is a liquid crystal panel including a pair of substrates with liquid crystals sealed therebetween.

10. A television device comprising the display device according to claim 8.
